(19) United States
(12) Patent Application Publication
(10) Pub. No.: US 2011/0244438 A1
(43) Pub. Date: Oct. 6, 2011

(54) Children's Musical Book

(76) Inventor: Christian Noel Guy Legrand, Nonthaburi (TH)

(21) Appl. No.: 12/938,431

(22) Filed: Nov. 3, 2010

(30) Foreign Application Priority Data
Apr. 6, 2010 (EM) 10380051.2

(51) Int. Cl. G09B 5/00

(52) U.S. Cl. 434/317

(57) ABSTRACT

A children's musical book includes an electronic audio circuit which is able to generate music or any other type of sound. It includes a back cover (3) of considerable thickness in which there is a hollow (6) of dimensions that make it suitable for holding the electronic audio circuit (7) together with its keypad (8), battery (9), loudspeaker (10) and wiring (11), while both surfaces of the back cover (3) are covered by sheets of cardboard (15), so that the circuit occupies the minimum space and is perfectly protected within the back cover. Additionally, the back cover, cover and inside pages are composed of a central core of foam rubber (4, 4′), which is covered on both sides by the said sheets of cardboard (5), the free edges of which are tucked in respecting the edge of the foam rubber core that are likewise free, these latter being those on which manual contact takes place during normal usage of the book.

### FIELD OF THE INVENTION

This invention refers to a children's book, specifically a musical book, that is a book in which graphic information is complemented by an acoustic device which is able to reproduce or generate any type of sounds, all the same if it is music or sounds of different types.

The object of the invention is to obtain a book that offers optimum performance from the point of view of safety, regarding the circuitry which makes it musical, as well as the child or user of the book, taking into account the maltreatment in handling suffered by books of any type when used by young children.

### BACKGROUND OF THE INVENTION

Musical books are known, understanding musical to refer to their capacity to generate sounds, these books having a structure based on a rigid cover, inside which a series of pages are bound which show a range of graphics, corresponding to the conceptual content of the book, these pages usually being made of strong paper which is able to withstand handling by a child.

The book itself is supplemented by an electronic circuit which includes a keypad, and which is able to generate sounds, music or any other type of acoustic signal in connection with the graphic content of the book.

The electronic circuit is usually held within a protective housing that is conveniently affixed to any appropriate part of the book, such as its cover.

This structure has a broad and varied range of problems, which basically centre on the following aspects:

Given that in its normal usage the book will be subjected to frequent falls, there is a high risk that the housing containing the acoustic circuit will break, with the subsequent damage to or definitive breakage of the said circuit.

Technically this problem could be solved by means of using a sufficiently rigid housing to withstand the impacts, but this would involve a notable increase in the cost of the book, as well as an increase in its weight, etc.

As the pages of the book have edges that can cut, they give rise to a permanent risk of harming the hands of children.

The rigidity of the cover, and most particularly of the housing that contains the circuit, also gives rise to a risk of harming the child when the book falls from his hand onto one of his feet, for example.

Between the spine of the cover and the interior binding a gap or orifice appears when the book is open, which when closing the book may trap one of the fingers of the hand of a child, with the resulting risk of harming it.

The weight of the book itself, together with the weight of the components of the electronic audio circuit, cause the book to be hard for a young child to handle.

In the attempt to prevent the first of the said problems, books are known that, maintaining their structural characteristics in terms of their cover and pages that contain graphic information, have on their back cover or rear part of the cover an extension outwards that makes it possible to insert the housing that contains the electronic circuit; however this solution, even though notably reduces the dimensions of these books, above all in terms of their thickness, does not solve any of the other problems described above, as the said housing is still directly liable to receive impacts and is therefore easily breakable.

### SUMMARY OF THE INVENTION

The children's musical book proposed by this invention solves the problems described above in a completely satisfactory way, in all of the different aspects that are mentioned.

To this end, one of the essential characteristics of the suggested book is that its back cover takes the form of a sheet of spongy material, very soft, such as foam rubber, for example, with rounded edges, and with a window in it of suitable shape and dimensions to receive and hold an electronic audio circuit, with its corresponding keypad, selecting for this purpose one of the circuits available in the market with the least possible thickness.

This window is open towards one of the free edge of the foam rubber sheet, to permit the insertion and extraction of the battery module of the circuit.

The largest surfaces of said foam rubber sheet are covered with cardboard sheets remain slightly distant from the edges of the foam rubber sheet, so that in normal usage of the book it is practically impossible for the hands to make direct physical contact with the edges of the said cardboard sheets.

One of these sheets, preferentially the inner one, is in turn equipped with a window giving access to the keypad of the electronic circuit, as well as a small hole placed functionally opposite the loudspeaker of the circuit.

The above mentioned inner sheet of cardboard which forms a part of the back cover of the book is prolonged alongside to the line along which the said back cover is hinged, so forming another sector that corresponds to the penultimate page of the book, which is also a sheet of foam rubber, considerably narrower and which protrudes beyond the edges of the cardboard; this structure is repeated as many times as is necessary for the total number of pages in the book, up to the corresponding front cover, also considerably less thick than the back cover, as it is unnecessary to hold any mechanism within it.

According to another one of the characteristics of the invention, the inner page of the back cover is larger than the front cover and the other pages of the book, so that the keypad of the audio circuit is directly accessible without the need to open the book.

Lastly, the spine of the book takes the form of a textile sheet that is affixed to the corresponding edges of the covers and inner pages, so that when the book is opened no room is left in this area where one of the fingers of a child could be trapped.

In this way a musical book for children is obtained that is considerably lighter in weight than children's books with a similar purpose, in which the electronic audio circuit is perfectly protected and able to withstand impacts or falls of considerable intensity, and which also amounts to a complete guarantee for the safety of the child who handles it.

### DESCRIPTION OF THE DRAWINGS

To complement the description of the invention and for a better comprehension of its characteristics we attach a set of drawings representing a preferential example of the practical embodiment of the invention which is not restricted to the contents of the following figures:

FIG. 1.—This shows, according to a general perspective view, a children's musical book made according to this invention, in the closed position.

FIG. 2.—This shows, also in a perspective view, the same book as in the previous figure, but in an open position, showing the internal surface of its back cover, which contains the mechanisms that make the book musical.

FIG. 3.—This shows a detail of the device in FIG. 2, in which the sheet of cardboard that covers the inside of the back cover is shown in partial cross-section, to show the internal structure of the said back cover.

FIG. 4.—This shows another view of the book as a whole, closed, in contrast with the view in FIG. 1.

### DETAILED DESCRIPTION OF THE PREFERRED EMBODIMENT

In the light of the said figures it may be seen that the book proposed by the invention, like any conventional book, has a front cover (1), a series of pages (2) and a back cover (3), but with the particularity that each one of these elements has the structure of a core in the form of a sheet (4) of sufficiently dense foam rubber, but which is soft and light, this core or central sheet being covered on both its surfaces by sheets of cardboard (5), of reduced thickness, the free edges of which are noticeably distant from the edges of the core (4), as may be seen in the enlarged detail of FIG. 2, so that the edges of the cardboard are inaccessible in normal handling of the book, in which children's hands will only touch the soft foam rubber core.

Each sheet of cardboard (5) is shared by two adjacent pages, so that they function simultaneously as means of binding or hinging the book.

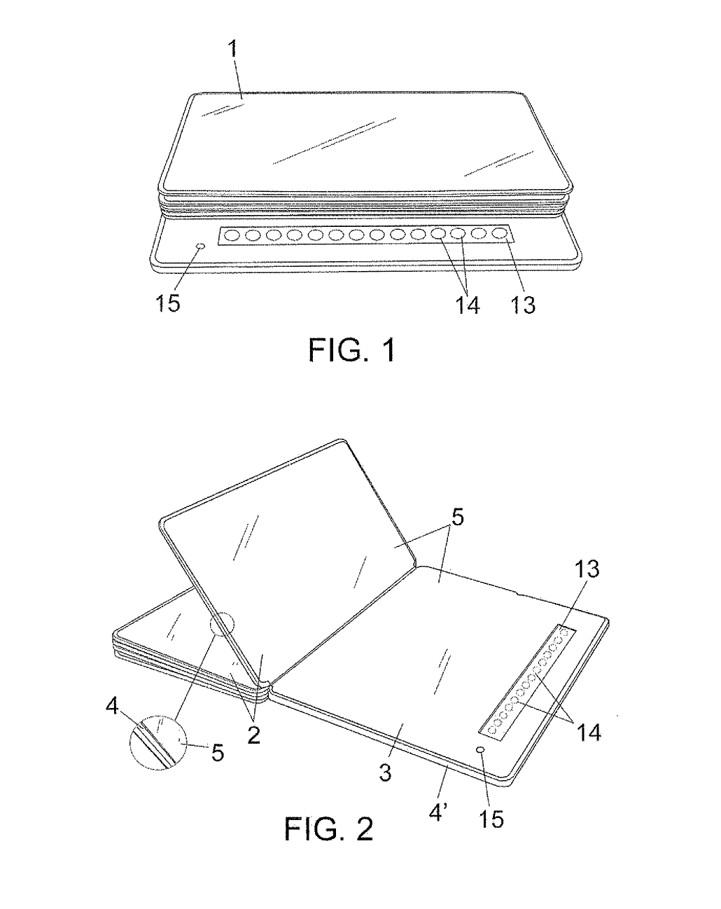

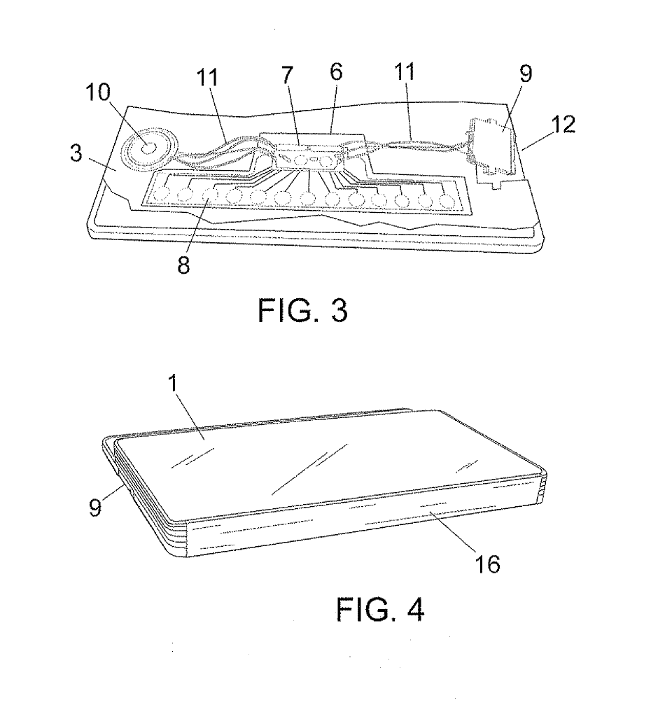

The sheet (4′) that is used in the back cover (3) is considerably thicker than the one in the front cover (1) and the one in the inside pages, and in the back cover (3) it is considerably wider than the other pages and the cover (1), so that when the book is closed the said back cover (3) projects substantially, as may be seen in FIG. 1.

The core (4′) of the back cover (3) is thicker because it holds, protected by the corresponding sheets of cardboard (5), the electronic audio circuit, which will be described below.

To this end the said core (4′) of the back cover (3) has a window or hole (6) of a shape and dimensions that are suitable to tightly hold inside the electronic audio circuit, specifically the circuit itself (7), the keypad (8), the battery that powers (9) the said circuit, and its accessory loudspeaker (10), as well as the corresponding (11) connections between these elements.

The window or hole (6) in the foam rubber core (4′) which forms a part of the back cover (3), opens towards one of the edges of the back cover in a mouth (12) to permit access to the battery compartment (9), while in the cardboard sheet (5) which covers the inside of the back cover, there is a rectangular long window (13) which permits direct access to the keys (14) of the keypad (8), while in the said cardboard sheet (5), preferentially in alignment with the keypad (8), there is a small orifice (15) which is functionally in front of the loudspeaker (10).

According to this structure, the book proposed by the invention is especially suitable to be a book-piano, making it possible for the child to create music, using the keypad (8), although this application is not a limitation at all, given that evidently the keys (14) of the said keypad (8) may have any other function that is considered advisable, such as for example using each one of the keys to reproduce the sound of a certain animal, which could be identified graphically on the corresponding key.

The safety for the child arising from the fact that all of the elements of which the book is composed, that is its pages as well as its front cover and back cover, have soft and rounded edges, is reinforced by the special binding of the book that makes it possible to use a spine (16) in the form of fabric the longitudinal edges of which are covered and protected by the external sheet of cardboard corresponding to the front cover and back cover, and the central area of which is affixed using an adhesive to the edge of the foam rubber core of the cover, of its inner page of all the inside pages, so that there are no cavities when the book is open, which could close over the fingers of a child when the book is closed.

Lastly, although this invention has been executed on the basis of a keypad (14) which is accessible through a window (13) in the back cover of the book, the keys may be dispersed on any of its pages, obviously with the corresponding wiring to connect them with the circuit (7), established within the cores of those pages for which this is necessary.

It is also optional for the electronic circuitry of the book to include a display or screen, to show any type of information for the user of the book.

1. A musical children's book that is able to generate musical sounds as well as sounds of other types, the structure of which is based on a front cover, a back cover and a plurality of inside pages, duly bound, which also includes an electronic audio circuit, with its corresponding keypad, characterised by the fact that structure of the back cover includes a core (4′), made of a light soft material, preferentially foam rubber of considerable thickness, in which there is a hollow (6) of a shape and dimensions suitable for lodging the electronic audio circuit, including all of its components, the said hollow being closed by means of two sheets (5) of cardboard, one of the external and the other one internal, the laster presenting a window (13) giving direct access to the keypad (8).

2. A musical children's book, according to claim 1, characterised by the fact that the hollow (6) in the foam rubber core (4′) of the back cover (3), opens towards one of the edges of the said back cover, corresponding to the place where the battery (9) of the electronic audio circuit is located, so that this battery may be replaced or recharged.

3. A musical children's book, according to claim 1, characterised by the fact that the sheets of cardboard (5) that cover the inside and outside surfaces of the back cover, are smaller than the foam rubber core (4′), in such a way that the three free edges of the said sheet of cardboard are distant from the corresponding edges of the foam rubber core.

4. A musical children's book, according to claim 2, characterised by the fact that the sheets of cardboard (5) that cover the inside and outside surfaces of the back cover, are smaller than the foam rubber core (4′), in such a way that the three free edges of the said sheet of cardboard are distant from the corresponding edges of the foam rubber core.

5. A musical children's book, according to claim 1, characterised by the fact that the cover (1) as well as the inside pages (2), have a structure that also includes a foam rubber core (4), each side of which is covered by a sheet of cardboard (5), the free edges of which are distant from the free edges of the foam rubber core (4).′

6. A musical children's book, according to claim 2, characterised by the fact that the cover (1) as well as the inside pages (2), have a structure that also includes a foam rubber core (4), each side of which is covered by a sheet of cardboard (5), the free edges of which are distant from the free edges of the foam rubber core (4).′

7. A musical children's book, according to claim 3, characterised by the fact that the cover (1) as well as the inside pages (2), have a structure that also includes a foam rubber core (4), each side of which is covered by a sheet of cardboard (5), the free edges of which are distant from the free edges of the foam rubber core (4).′

8. A musical children's book, according to claim 4, characterised by the fact that the cover (1) as well as the inside pages (2), have a structure that also includes a foam rubber core (4), each side of which is covered by a sheet of cardboard (5), the free edges of which are distant from the free edges of the foam rubber core (4).′

9. A musical children's book, according to claim 1, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.

10. A musical children's book, according to claim 2, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.

11. A musical children's book, according to claim 3, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.

12. A musical children's book, according to claim 4, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.

13. A musical children's book, according to claim 5, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.

14. A musical children's book, according to claim 6, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.

15. A musical children's book, according to claim 7, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.

16. A musical children's book, according to claim 8, characterised by the fact that the sheets of cardboard (5) that overlay the covers and inside pages of the book, extend as a single piece from page to page, through a line of folding, determining the means of binding the book, which are complemented by a textile sheet located over the spine of the book, the longitudinal edges of the textile sheet being located under the external cardboard sheets of the cover, while in its central zone it is affixed to the free and corresponding edge of all the foam rubber cores in the book.
